(19) United States
(12) Patent Application Publication
(10) Pub. No.: US 2025/0354287 A1
(43) Pub. Date: Nov. 20, 2025

(54) MULTI-COLOR APPLICATION METHOD AND DEVICE FOR ALUMINUM ALLOY WHEEL

(71) Applicant: CITIC Dicastal Co., Ltd, Qinhuangdao (CN)

(72) Inventors: Mengnan Ma, Qinhuangdao (CN); Shaokang Bian, Qinhuangdao (CN); Zaide Wang, Qinhuangdao (CN); Lichong Li, Qinhuangdao (CN); Chuan Li, Qinhuangdao (CN); Chao Ma, Qinhuangdao (CN); Chuanming Li, Qinhuangdao (CN); Shiwen Xu, Qinhuangdao (CN); Bitao Zhang, Qinhuangdao (CN); Shengchao Zhang, Qinhuangdao (CN); Shi Wang, Qinhuangdao (CN); Xuelei Feng, Qinhuangdao (CN)

(73) Assignee: CITIC Dicastal Co., Ltd, Qinhuangdao (CN)

(21) Appl. No.: 19/246,554

(22) Filed: Jun. 23, 2025

(30) Foreign Application Priority Data
Jun. 26, 2024 (CN) 202410837934.4

(51) Int. Cl. C25D 11/36

(52) U.S. Cl. CPC C25D 11/36

(57) ABSTRACT

A multi-color application method and device for an aluminum alloy wheel. The method is used for preparing a wear-resistant ceramic layer on a surface of the aluminum alloy wheel by using a plasma coating (PLMC) system, includes the steps of: pretreating the wheel, spraying an insulating powder coating, curing an insulating powder coating, making a multi-color pattern, cleaning the multi-color pattern, forming a PLMC, performing blocking, performing water washing, drying the PLMC, forming a transparent powder coating, curing a transparent powder coating, forming the PLMC includes preparation of a ceramic film at a multi-color application position, an electrolyte is a phosphate-silicate system, and the PLMC system is provided with: a power supply, a mechanical arm and a plurality of oxidation tanks, the mechanical arm plays a supporting role in wheel transportation and an oxidation process; and the oxidation tanks are used to prepare the PLMC with different colors in the electrolyte.

### TECHNICAL FIELD

The present disclosure relates to the field of aluminum alloy wheel surface treatment, in particular to a multi-color application method and device for an aluminum alloy wheel.

### BACKGROUND

Aluminum alloy is an excellent metallic material, has high specific strength and good workability, and is widely used in the automotive hub industry. At present, a finish turning process for aluminum alloy wheels involves finish turning, certain pretreatment, and directly spraying a transparent coating, which also causes the corrosion resistance of the finish-turned surfaces of the aluminum alloy wheels to be worse than that of fully coated surfaces. At the same time, various solutions such as an acid and an alkali are used in the pretreatment process, and wastewater treatment is complicated.

### SUMMARY

In order to solve the above problems, an object of the present disclosure is to provide a surface treatment method and device capable of realizing two-color or multi-color and personalized pattern effects on a front surface of a hub while improving the corrosion resistance of an aluminum alloy wheel.

According to one aspect of the present disclosure, provided is a multi-color application method for an aluminum alloy wheel, wherein the method is used for preparing a wear-resistant ceramic layer on a surface of the aluminum alloy wheel by using a plasma coating (PLMC) system, and includes the steps of: pretreating the aluminum alloy wheel, spraying an insulating powder coating, curing an insulating powder coating, making a multi-color pattern, cleaning the multi-color pattern, forming a PLMC, performing blocking, performing water washing, drying the PLMC, forming a transparent powder coating, and curing a transparent powder coating, wherein the insulating powder coating is one selected from polyester resin, epoxy resin, and epoxy-polyester resin, the insulating powder coating is cured at a temperature controlled to be 160-200° C. for 10-60 min, making the multi-color pattern includes: removing the insulating coating according to a corresponding multi-color application position of a design pattern to expose a base aluminum alloy layer, forming the PLMC includes preparation of a ceramic film at a multi-color application position, wherein an electrolyte is a phosphate-silicate system including 10-50 g/L of sodium metaphosphate, 2-10 g/L of sodium silicate, 2-8 g/L of boric acid, and 2-12 g/L of a dense additive, the dense additive is selected from one or more of sodium tungstate, potassium titanium oxalate, sodium meta aluminate, ammonium metavanadate, and citrate, a blocking process is organic zirconium-titanium hybridization, the PLMC is dried for 20-60 min at a temperature controlled to be 120-150° C., a material used for the transparent powder coating is selected from acrylic acid and polyester, and the transparent powder is cured at a temperature controlled to be 150-200° C. for 10-80 min, wherein the PLMC system is provided with: a power supply, a mechanical arm and a plurality of oxidation tanks, wherein the mechanical arm plays a supporting role in wheel transportation and an oxidation process; and the oxidation tanks are used to prepare the PLMC with different colors in the electrolyte.

Preferably, the pretreating includes the steps of degreasing, water washing, pickling, water washing, blocking, water washing, and baking the aluminum alloy wheel.

Preferably, making the multi-color pattern includes finish milling the multi-color pattern by finish turning and milling-turning, or performing engraving according to the design pattern by laser engraving.

Preferably, cleaning the multi-color pattern includes surface degreasing and water washing of the finish-milled multi-color pattern.

Preferably, the insulating powder coating uses the epoxy-polyester resin, and is cured at a temperature controlled to be 180° C. for 15 min, the multi-color pattern is made by finish turning, the power supply uses a constant voltage mode, a voltage is 320 V, the corresponding time is 9 min, a frequency is 500 Hz and adjustable, a duty ratio is 6%, and the electrolyte is the phosphate-silicate system including: 40 g/L of sodium metaphosphate, 8 g/L of sodium silicate, 4 g/L of boric acid, and 3 g/L of sodium tungstate, the PLMC is dried for 30 min at a temperature controlled to be 120° C., and the transparent powder coating uses high-gloss acrylic resin and is cured at a temperature controlled to be 180° C. for 18 min.

Preferably, the insulating powder coating uses the epoxy-polyester resin, and is cured at a temperature controlled to be 180° C. for 15 min, the multi-color pattern is made by finish turning, the power supply uses a constant voltage mode, a voltage is 310 V, the corresponding time is 9 min, a frequency is 500 Hz and adjustable, a duty ratio is 6%, and the electrolyte is the phosphate-silicate system including: 40 g/L of sodium metaphosphate, 8 g/L of sodium silicate, 4 g/L of boric acid, and 3 g/L of sodium tungstate, the PLMC is dried at a temperature controlled to be 120° C. for 30 min, and the transparent powder coating uses high-gloss acrylic resin and is cured at a temperature controlled to be 180° C. for 18 min.

According to another aspect of the present disclosure, provided is a multi-color application device for an aluminum alloy wheel, used to realize the multi-color application method for an aluminum alloy wheel as described above, wherein a power supply has an adjustable current of 0-100 A, an adjustable voltage of 0-750 V, an adjustable frequency of 30-3000 Hz, and an adjustable duty ratio of 3%-90%, and is provided with a constant voltage mode, a constant current mode, a multi-stage voltage mode, or a multi-stage current mode.

In this way, the ceramic layer with high corrosion resistance and wear resistance can be prepared on the surface of the aluminum alloy wheel by the method of the present disclosure to achieve multi-color application.

### BRIEF DESCRIPTION OF DRAWINGS

FIG. 1 is a diagram of a real object prepared by a multi-color application method and device for an aluminum alloy wheel according to an embodiment of the present disclosure.

FIG. 2 schematically shows a configuration diagram of a PLMC system.

FIG. 3 shows tape adhesion test results.

FIG. 4 shows neutral salt spray test results.

FIG. 5 shows copper accelerated acetic acid salt spray (CASS) test results.

FIG. 6 shows filiform test results.

FIG. 7 shows thermal shock test results.

FIG. 8 shows high humidity test results.

### DETAILED DESCRIPTION OF THE INVENTION

Exemplary embodiments of the present disclosure are described in detail below with reference to the accompanying drawings. The exemplary embodiments described below and illustrated in the drawings are intended to teach the principles of the present disclosure and to enable those skilled in the art to implement and use the present disclosure in several different environments and for several different applications. Therefore, the scope of protection of the present disclosure is defined by the appended claims, and the exemplary embodiments are not intended to be and should not be construed as a limiting description of the scope of protection of the present disclosure. Moreover, for ease of description, the dimensions of the various parts shown in the drawings are not necessarily drawn according to an actual scale. Orientation descriptions involved, such as an orientation or positional relationship indicated by terms such as front, back, upper, lower, left, right, top, and bottom are all based on the orientation or positional relationship shown in the drawings, are merely for ease of description of the present disclosure and for simplicity of description, and are not intended to indicate or imply that the device or element referred to must have a particular orientation, be constructed and operated in a particular orientation, and are therefore not to be construed as limiting the present disclosure. Unless otherwise specifically stated, the sequence of components and assembly steps and the numerical values set forth in the embodiments do not limit the scope of the present disclosure. Moreover, any numerical range stated herein is intended to include all sub-ranges contained therein, and a numerical range represented by “a numerical value A to a numerical value B” refers to a range including end point numerical values A and B. It will be understood by those skilled in the art that the terms “first”, “second”, “step” and the like in the present disclosure are used only to distinguish different steps, devices or modules, or the like, and do not represent any particular technical meaning nor the necessary logical order between different steps, devices or modules. For example, certain steps 2 and 3 may be swapped or performed in parallel.

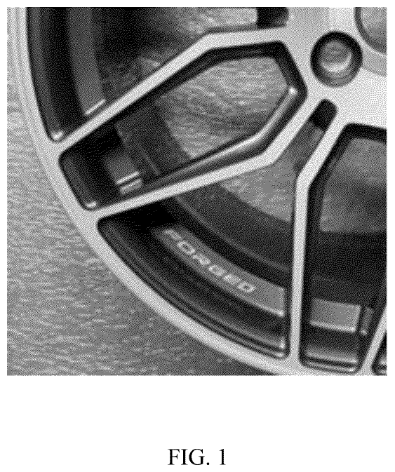

A multi-color application method for an aluminum alloy wheel (also referred to as surface treatment method) according to the present disclosure employs an aluminum alloy plasma coating (PLMC) technology to prepare a wear-resistant ceramic layer on the surface of the aluminum alloy wheel, and is suitable for multi-color application of a ceramic film on the surface of the aluminum alloy wheel, as shown in FIG. 1.

A PLMC system is used during preparation of the ceramic film, and a multi-color ceramic film layer with low porosity, high compactness, and high corrosion resistance is prepared in an electrolyte, and a PLMC has higher wear resistance and corrosion resistance, greatly improving the corrosion resistance of the aluminum alloy wheel, and prolonging the service life of the aluminum alloy wheel.

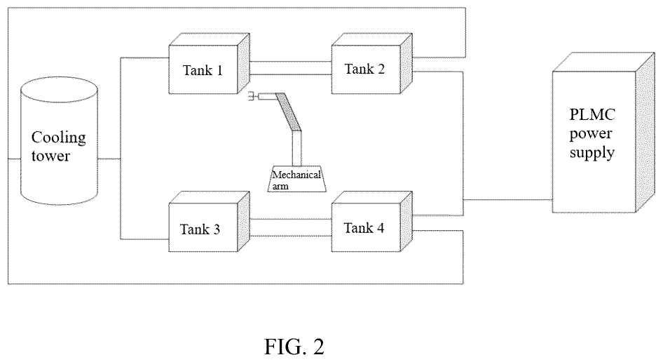

As shown in FIG. 2, the PLMC system is provided with a power supply special for the PLMC system, a rotating wheel mechanical arm and a plurality of oxidation tanks (four tanks 1-4 illustrated in the figure). The mechanical arm plays a supporting role in wheel transportation and an oxidation process; and the oxidation tanks are used for the production of the PLMC with different colors. In the production process, a metal is used as an anode and immersed in the electrolyte, parameters are controlled by the power supply of the PLMC system, and a multi-color ceramic film having wear resistance and corrosion resistance is formed on the surface of the metal by a chemical reaction.

Related device parameters of the power supply of the PLMC system are as follows: an adjustable current of 0-100 A, an adjustable voltage of 0-750 V, an adjustable frequency of 30-3000 Hz, and an adjustable duty ratio of 3%-90%, and the power supply can be provided with a constant voltage mode, a constant current mode, a multi-stage voltage mode, or a multi-stage current mode, but is not limited to these modes.

The multi-color application method for an aluminum alloy wheel according to the present disclosure includes the steps of: pretreating the aluminum alloy wheel, spraying an insulating powder coating, performing curing, making a multi-color pattern, performing cleaning, forming a PLMC, performing blocking, performing water washing, performing drying, forming a transparent powder coating, and performing curing.

The pretreating includes the steps of degreasing, water washing, pickling, water washing, blocking, water washing and baking the aluminum alloy wheel to ensure cleaning of the surface of the wheel before powder spraying is performed.

The insulating powder coating is one of polyester resin, epoxy resin, epoxy-polyester resin and the like.

The insulating powder coating is cured at a temperature controlled to be 160-200° C. for 10-60 min.

Finish milling the multi-color pattern can include performing engraving according to a design pattern by using various ways such as finish turning, milling-turning, and laser engraving to remove the insulating coating to expose a base aluminum alloy layer.

Cleaning includes surface degreasing and water washing of the finish-milled multi-color pattern to ensure surface cleanliness.

Forming the PLMC includes preparation of a ceramic film at a multi-color application position, wherein an electrolyte is a phosphate-silicate system, including 10-50 g/L of sodium metaphosphate, 2-10 g/L of sodium silicate, 2-8 g/L of boric acid, and 2-12 g/L of a dense additive, and the dense additive is one or a combination of more of sodium tungstate, titanium potassium oxalate, sodium meta aluminate, ammonium metavanadate, and citrate.

A blocking process is organic zirconium-titanium hybridization for filling the microporous structure of the PLMC, improving the adhesion between layers.

The PLMC is dried at a temperature controlled to be 120-150° C. for 20-60 min.

A material used for the transparent powder coating is one of acrylic acid, polyester and the like, and the transparent powder coating is matte or highly glossy.

The transparent powder is cured at a temperature controlled to be 150-200° C. for 10-80 min.

### Embodiment 1

Provided are a multi-color application method and device for an aluminum alloy wheel, and a specific embodiment is as follows:

A wear-resistant ceramic layer is prepared on the surface of the aluminum alloy wheel by using a PLMC method, and a ceramic film layer having high compactness is prepared in an electrolyte by using a constant voltage mode of a PLMC power supply in a PLMC system.

The aluminum alloy wheel is pretreated, an insulating powder coating is sprayed, curing is performed, a multi-color pattern is finish-milled, cleaning is performed, a PLMC is formed, blocking is performed, water washing is performed, drying is performed, a transparent powder coating is formed, and curing is performed.

The insulating powder coating uses epoxy-polyester resin. The insulating powder coating is cured at a temperature controlled to be 180° C. for 15 min.

Fine milling the multi-color pattern is completed by finish turning.

The power supply of the PLMC system is a multifunctional adjustable power supply, and uses a constant voltage mode, a voltage is 320 V, the corresponding time is 9 min, a frequency is 500 Hz and adjustable, and a duty ratio is 6%. The electrolyte in the PLMC system is a phosphate-silicate system containing: 40 g/L of sodium metaphosphate, 8 g/L of sodium silicate, 4 g/L of boric acid, and 3 g/L of sodium tungstate.

A blocking process uses organic zirconium-titanium hybridization for filling the microporous structure of the PLMC, improving the adhesion between layers.

The PLMC is dried at a temperature controlled to be 120° C. for 30 min.

The transparent powder coating uses high-gloss acrylic resin and is cured at a temperature controlled to be 180° C. for 18 min.

### Embodiment 2

Provided are a multi-color application method and device for an aluminum alloy wheel, and a specific embodiment is as follows:

A wear-resistant ceramic layer is prepared on the surface of the aluminum alloy wheel by using a PLMC method, and a ceramic film layer having high compactness is prepared in an electrolyte by using a constant voltage mode of a PLMC power supply in a PLMC system.

The aluminum alloy wheel is pretreated, an insulating powder coating is sprayed, curing is performed, a multi-color pattern is finish-milled, cleaning is performed, a PLMC is formed, blocking is performed, water washing is performed, drying is performed, a transparent powder coating is formed, and curing is performed.

The insulating powder coating uses epoxy-polyester resin, and is cured at a temperature controlled to be 180° C. for 15 min.

Fine milling the multi-color pattern is completed by finish turning.

The power supply of the PLMC system is a multifunctional adjustable power supply, and uses a constant voltage mode, a voltage is 310 V, the corresponding time is 9 min, a frequency is 500 Hz and adjustable, and a duty ratio is 6%. The PLMC electrolyte is a phosphate-silicate system containing: 40 g/L of sodium metaphosphate, 8 g/L of sodium silicate, 4 g/L of boric acid, and 3 g/L of sodium tungstate.

A blocking process uses organic zirconium-titanium hybridization for filling the microporous structure of the PLMC, improving the adhesion between layers.

The PLMC is dried at a temperature controlled to be 120° C. for 30 min.

The transparent powder coating uses high-gloss acrylic resin and is cured at a temperature controlled to be 180° C. for 18 min.

Compared with the prior art, the present disclosure has the following characteristics:

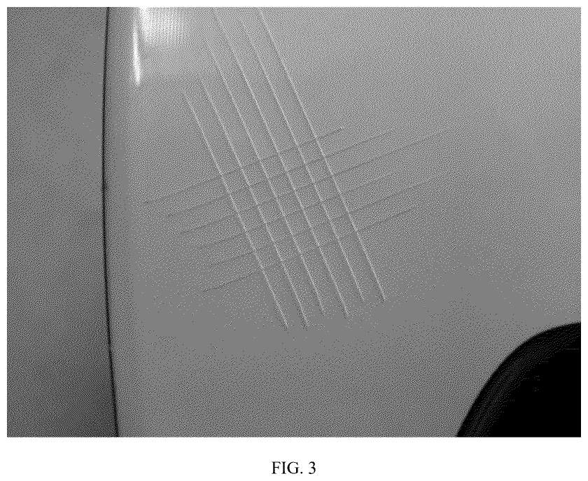

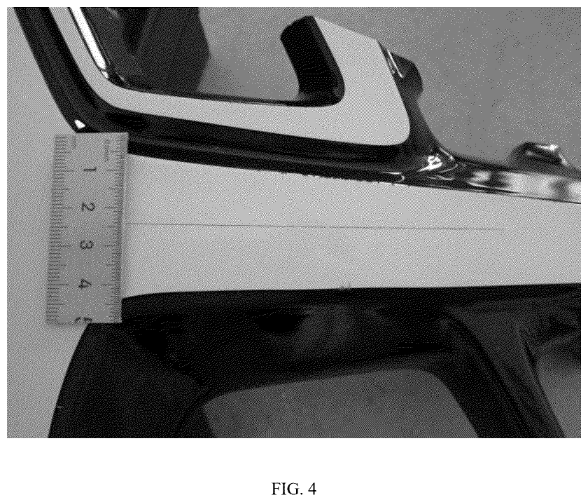

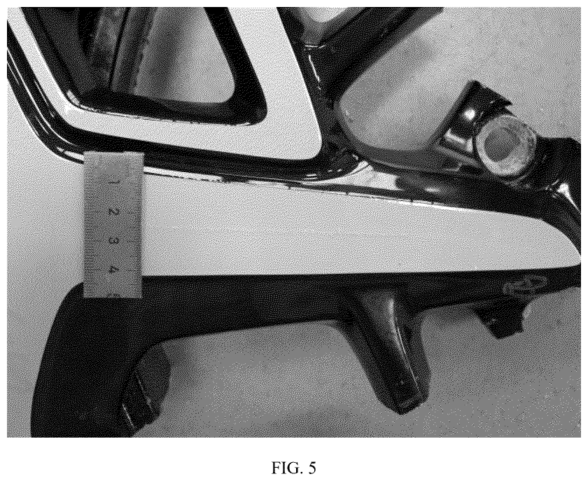

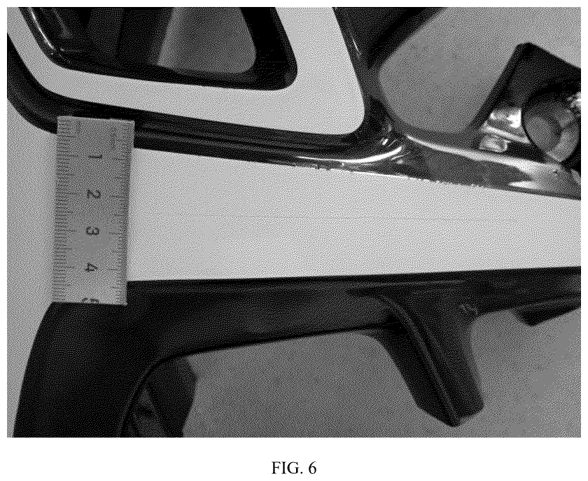

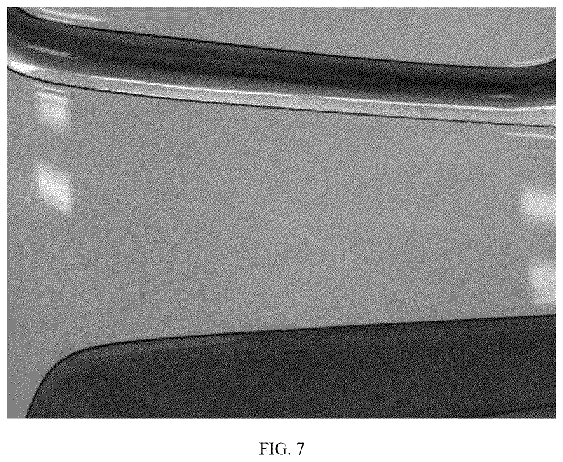

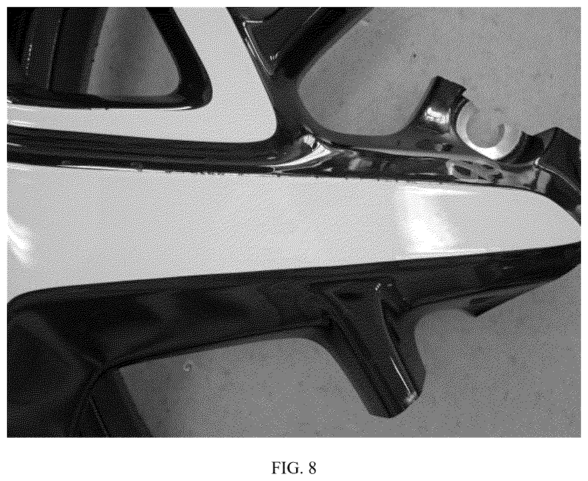

1. In the present disclosure, the ceramic layer prepared on the surface of the aluminum alloy wheel has high corrosion resistance and wear resistance, as shown in the following table.

| | | | Result | |
|---|---|---|---|---|
| Detection item | Standard | Detection device | determination | Picture |
| Tape adhesion | GMW14829: 2017 | Scribing knife | Qualified | FIG. 3 |
| test | | | | |
| Neutral salt | GMW3286: 2021, | (SF3600) salt | Qualified | FIG. 4 |
| spray test | and GMW15282: | spray test | | |
| | 2012 | chamber | | |
| Copper | GMW14458: 2020, | (DBL-240NS) | Qualified | FIG. 5 |
| accelerated | and GMW15282: | salt spray test | | |
| acetic acid salt | 2012 | chamber | | |
| spray (CASS) | | | | |
| test | | | | |
| Filiform test | GMW14458: 2020, | (417522) | Qualified | FIG. 6 |
| | GMW15287: 2018, | Filiform test | | |
| | and GMW15282: | chamber | | |
| | 2011 | | | |
| Thermal shock | GMW15919: 2019 | Thermal shock | Qualified | FIG. 7 |
| test | | tester | | |
| High humidity | GMW14729: 2020 | (ZN-L500) | Qualified | FIG. 8 |
| test | | condensation | | |
| | | water test | | |
| | | chamber | | |

2. The method of the present disclosure adopts the constant voltage mode of the multifunctional adjustable power supply, the obtained film layer has high compactness, and sewage generated in the preparation process has no pollution to the environment, thus achieving green and sustainable development.

The specific meanings of the above terms in the present disclosure can be understood according to specific circumstances by those of ordinary skill in the art. Although the present disclosure has been described with reference to various specific embodiments, it should be understood that variations can be made within the spirit and scope of the inventive concepts described. Therefore, it is intended that the present disclosure is not limited to the embodiments described, but will have the full scope defined by the language of the appended claims.

What is claimed is:

1. A multi-color application method for an aluminum alloy wheel, wherein the method is used for preparing a wear-resistant ceramic layer on a surface of the aluminum alloy wheel by using a plasma coating (PLMC) system, and comprises the steps of: pretreating the aluminum alloy wheel, spraying an insulating powder coating, curing an insulating powder coating, making a multi-color pattern, cleaning the multi-color pattern, forming a PLMC, performing blocking, performing water washing, drying the PLMC, forming a transparent powder coating, and curing a transparent powder coating,
the insulating powder coating is one selected from polyester resin, epoxy resin, and epoxy-polyester resin,
the insulating powder coating is cured at a temperature controlled to be 160-200° C. for 10-60 min,
making the multi-color pattern comprises: removing the insulating coating according to a corresponding multi-color application position of a design pattern to expose a base aluminum alloy layer,
forming the PLMC comprises preparation of a ceramic film at a multi-color application position, wherein an electrolyte is a phosphate-silicate system, comprising 10-50 g/L of sodium metaphosphate, 2-10 g/L of sodium silicate, 2-8 g/L of boric acid, and 2-12 g/L of a dense additive, and the dense additive is one or more selected from sodium tungstate, titanium potassium oxalate, sodium meta aluminate, ammonium metavanadate, and citrate,
a blocking process is organic zirconium-titanium hybridization,
the PLMC is dried for 20-60 min at a temperature controlled to be 120-150° C.,
a material used for the transparent powder coating is selected from acrylic acid and polyester,
the transparent powder is cured at a temperature controlled to be 150-200° C. for 10-80 min, and
wherein the PLMC system is provided with: a power supply, a mechanical arm and a plurality of oxidation tanks, wherein the mechanical arm plays a supporting role in wheel transportation and an oxidation process; and the oxidation tanks are used to prepare the PLMC with different colors in the electrolyte.

2. The multi-color application method for an aluminum alloy wheel according to claim 1, wherein the pretreating comprises the steps of degreasing, water washing, pickling, water washing, blocking, water washing, and baking the aluminum alloy wheel.

3. The multi-color application method for an aluminum alloy wheel according to claim 1, wherein making the multi-color pattern comprises finish milling the multi-color pattern by finish turning and milling-turning, or performing engraving according to the design pattern by laser engraving.

4. The multi-color application method for an aluminum alloy wheel according to claim 1, wherein cleaning the multi-color pattern comprises surface degreasing and water washing of the finish-milled multi-color pattern.

5. The multi-color application method for an aluminum alloy wheel according to claim 1, wherein the insulating powder coating uses the epoxy-polyester resin, and is cured at a temperature controlled to be 180° C. for 15 min,
the multi-color pattern is made by finish turning,
the power supply uses a constant voltage mode, a voltage is 320 V, the corresponding time is 9 min, a frequency is 500 Hz and adjustable, a duty ratio is 6%, and the electrolyte is the phosphate-silicate system comprising: 40 g/L of sodium metaphosphate, 8 g/L of sodium silicate, 4 g/L of boric acid, and 3 g/L of sodium tungstate,
the PLMC is dried for 30 min at a temperature controlled to be 120° C., and
the transparent powder coating uses high-gloss acrylic resin and is cured at a temperature controlled to be 180° C. for 18 min.

6. The multi-color application method for an aluminum alloy wheel according to claim 1, wherein the insulating powder coating uses the epoxy-polyester resin, and is cured at a temperature controlled to be 180° C. for 15 min,
the multi-color pattern is made by finish turning,
the power supply uses a constant voltage mode, a voltage is 310 V, the corresponding time is 9 min, a frequency is 500 Hz and adjustable, a duty ratio is 6%, and the electrolyte is the phosphate-silicate system comprising: 40 g/L of sodium metaphosphate, 8 g/L of sodium silicate, 4 g/L of boric acid, and 3 g/L of sodium tungstate,
the PLMC is dried at a temperature controlled to be 120° C. for 30 min, and
the transparent powder coating uses high-gloss acrylic resin and is cured at a temperature controlled to be 180° C. for 18 min.

7. A multi-color application device for an aluminum alloy wheel, used to realize the multi-color application method for an aluminum alloy wheel according to claim 1, wherein a power supply has an adjustable current of 0-100 A, an adjustable voltage of 0-750 V, an adjustable frequency of 30-3000 Hz, and an adjustable duty ratio of 3%-90%, and is provided with a constant voltage mode, a constant current mode, a multi-stage voltage mode, or a multi-stage current mode.
